(19) United States
(12) Patent Application Publication
(10) Pub. No.: US 2024/0233077 A1
(43) Pub. Date: Jul. 11, 2024

(54) IMAGE SUPER-RESOLUTION METHOD BASED ON KNOWLEDGE DISTILLATION COMPRESSION MODEL AND DEVICE THEREOF

(71) Applicant: Zhejiang University, Hangzhou City (CN)

(72) Inventors: Haoji HU, Hangzhou City (CN); Hangxiang FANG, Hangzhou City (CN); Tao OUYANG, Hangzhou City (CN); Kai LIU, Hangzhou City (CN); Yuanjia HUANG, Hangzhou City (CN); Yongwen LONG, Hangzhou City (CN)

(21) Appl. No.: 18/405,750

(22) Filed: Jan. 5, 2024

(30) Foreign Application Priority Data
Jan. 6, 2023 (CN) 202310018874.9

(51) Int. Cl. G06T 3/4053; G06T 5/60; G06T 5/73

(52) U.S. Cl. CPC G06T 3/4053; G06T 5/60; G06T 5/73; G06T 2207/20081; G06T 2207/20084; G06T 2207/20192

(57) ABSTRACT

An image super-resolution method based on a knowledge distillation compression model and a device thereof are disclosed. A small student network model is cascaded into a teacher network with high performance to better complete knowledge distillation, so that the performance of a student network can gradually approach the teacher network, and then the compression of a super-resolution network is completed. Using a distillation strategy of the present disclosure not only avoids manually designing feature conversion between different networks to align, but also greatly reduces the optimization difficulty of the student network. In order to alleviate the problem of inefficient distillation caused by a representation gap between teachers and students, the present disclosure regards a similarity relationship between layers of teachers as knowledge, so that students can learn the similarity relationship of teachers in their own space instead of directly imitating complex features of teachers. The present disclosure significantly compresses a parameter quantity and calculation consumption of a super-resolution network model, reduces the deployment difficulty of the super-resolution network model in an apparatus with limited resources, and has a strong practical application value.

### CROSS-REFERENCE TO RELATED APPLICATION

This patent application claims the benefit and priority of Chinese Patent Application No.202310018874.9 filed with the China National Intellectual Property Administration on Jan. 6, 2023, the disclosure of which is incorporated by reference herein in its entirety as part of the present application.

### TECHNICAL FIELD

The present disclosure relates to the field of deep learning, model compression, image super-resolution, etc., and in particular, to an image super-resolution method based on a knowledge distillation compression model and a device thereof.

### BACKGROUND

Image super-resolution^{[1]} (SR) is a basic task in computer vision, which intends to restore a high- resolution image with several times the size from a low- resolution image. Image super-resolution technology has a very broad application scene in industry, involving medical image analysis, satellite image analysis, face recognition, monitoring and so on. For example, when using satellites to shoot the terrain, an imaging device often has low resolution due to the limitations of power and storage space, which brings difficulties to terrain reconstruction, and then cannot meet the requirements of subsequent object recognition and analysis. In the massive security monitoring scene, due to the limitations of device cost and network bandwidth, the image resolution acquired in the monitoring environment is not high, which brings difficulties to data screening and analysis. With the rise of mobile devices, people have higher requirements for image quality, and thus under the limitations of the mobile network bandwidth and device performance, how to obtain pleasant high-resolution photos has been a research hotspot in recent years. However, image super-resolution is a challenging and essentially imperfect problem as when a high-definition image is converted to a low-definition image, detailed information will be lost, and in the reverse restoration, there are always multiple high-definition mappings in the low-definition image.

A traditional SR method is based on artificial feature extraction. Although the calculation speed is fast, the restored image is seriously distorted, and thus it is difficult to be applied to the actual scene. In recent years, a Convolutional Neural Network (CNN) has achieved great success in super-resolution tasks by designing end-to-end mapping. SRCNN^{[2]} only uses 3-layer convolution to achieve higher performance than the traditional method. Subsequent work focuses on improving performance by using wider, deeper and more efficient networks. Enhanced Deep super-resolution (EDSR)^{[3]} has removed a Batch Normalization (BN) layer and has stacked more convolution layers to achieve better performance, which greatly influences subsequent mainstream SR network design. Residual Channel Attention Network (RCAN)^{[4]} first introduces an attention mechanism into a super-resolution task, where a residual group is designed to reduce the difficulty of model training, so that the network reaches 400 layers. Residual Dense Network (RDN)^{[5]} proposes a dense connection network. In a dense connection module, the network sends feature maps generated by each layer to a subsequent convolution layer to fully integrate high-level and low-level features to generate rich feature representations. However, the huge computing requirement and memory occupation limit the practical industrial deployment of these networks.

On the other hand, Knowledge Distillation (KD), as a promising deep model compression technology, can make a small student network learn from a parameterized large teacher network and gradually approach the performance of the teacher network, so that the small network replaces the large network to complete the deployment. KD^{[6]} first proposes in the classification task that the performance of the student network is greatly improved by teaching soft labels generated in the teacher network. Later, Yim et al.^{[7]} propose that the flow between two layers of teachers should be regarded as knowledge, and the knowledge distillation should be guided according to the relationship between different layers. Teacher-Assistant Knowledge Distillation (TAKD)^{[8]} considers that too large ability difference between teachers and students will lead to an inefficient distillation. Recently, Jin et al.^{[9]} directly align the feature maps between teachers and students for distillation based on Centered Kernel Alignment (CKA)^{[10]}.

Applying KD to SR network can greatly reduce the dependence on computing resources on the basis of ensuring the image restoration effect, and then make the super-resolution technology to be widely used in practice. However, at present, little knowledge distillation work focuses on super-resolution tasks. Although the distillation method of a high-level visual task network has made some progress, it is very difficult to design feature alignment strategies for low-level visual tasks such as super-resolution, because it is difficult to design strategies to align complex textures generated by the network, and a certain transformation of feature maps will lead to information loss, which has a limited effect. In order to improve the distillation efficiency and further improve the visual restoration quality of the compressed model, it is necessary to use a new compression framework. The present disclosure designs a compression framework suitable for SR network. The present disclosure can greatly reduce the dependence of the algorithm on equipment resources on the basis of maintaining the image restoration effect. For example, for a blurred image taken by a mobile phone, a high-definition image can be obtained by using this method. Under the conditions of limited computing resources of a mobile phone and sensitive user latency, the super-resolution technology of images can be used to quickly complete images with high quality, so as to meet the demand of users for high-quality shooting.
[1]. William T Freeman and Egon C Pasztor. Learning low-level vision. In ICCV, 1999. Long J, Shelhamer E, Darrell T.
[2]. Chao Dong, Chen Change Loy, Kaiming He, and Xiaoou Tang. Image super-resolution using deep convolutional networks. IEEE transactionson pattern analysis and machine intelligence, 38(2):295-307, 2015.
[3]. Bee Lim, Sanghyun Son, Heewon Kim, Seungjun Nah, and Kyoung Mu Lee. Enhanced deep residual networks for single image super-resolution. In Proceedings of the IEEE conference on computer vision and pattern recognition workshops, pages 136-144, 2017.
[4]. Yulun Zhang, Kunpeng Li, Kai Li, Lichen Wang, Bineng Zhong, and Yun Fu. Image super-resolution using very deep residual channel attention networks. In Proceedings of the European conference on computer vision (ECCV), pages 286-301, 2018.
[5]. Yulun Zhang, Yapeng Tian, Yu Kong, Bineng Zhong, and Yun Fu. Residual dense network for image super-resolution. In Proceedings of the IEEE conference on computer vision and pattern recognition, pages 2472-2481, 2018.
[6]. Geoffrey Hinton, Oriol Vinyals, and Jeff Dean. Distilling the knowledge in a neural network. arXiv preprint arXiv: 1503.02531 Add to Citavi project by ArXiv ID, 2015.
[7]. Junho Yim, Donggyu Joo, Jihoon Bae, and Junmo Kim. A gift from knowledge distillation: Fast optimization, network minimization and transfer learning. In Proceedings of the IEEE Conference on Computer Vision and Pattern Recognition, pages 4133-4141, 2017.
[8]. Seyed Iman Mirzadeh, Mehrdad Farajtabar, Ang Li, Nir Levine, Akihiro Matsukawa, and Hassan Ghasemzadeh. Improved knowledge distillation via teacher assistant. In Proceedings of the AAAI Conference on Artificial Intelligence, volume 34, pages 5191-5198, 2020.
[9]. Qing Jin, Jian Ren, Oliver J Woodford, Jiazhuo Wang, Geng Yuan, Yanzhi Wang, and Sergey Tulyakov. Teachers do more than teach: Compressing image-to-image models. In Proceedings of the IEEE/CVF Conference on Computer Vision and Pattern Recognition, pages 13600-13611, 2021.
[10]. Simon Kornblith, Mohammad Norouzi, Honglak Lee, and Geoffrey Hinton. Similarity of neural network representations revisited. In International Conference on Machine Learning, pages 3519-3529. PMLR, 2019.

### SUMMARY

The present disclosure intends to compress the super-resolution network model, reduce the requirement for platform resources and maintain its image restoration ability. Aiming at the disadvantages of the existing compression technology in the application of super-resolution field, such as difficulty in feature alignment and low distillation efficiency, the present disclosure provides an image super-resolution method based on a knowledge distillation compression model and a device thereof to further improve the distillation effect.

The purpose of the present disclosure is achieved through the following technical solutions. In a first aspect, the present disclosure provides an image super-resolution method based on a knowledge distillation compression model, including following steps:
(1) acquiring a trained large teacher network and a small student network to be trained respectively, where the teacher network is an open and pre-trained network; the student network is a network obtained after reducing a depth of the teacher network, which will be used for actual deployment; the teacher network and the student network are respectively divided into two modules according to a network depth to obtain a first teacher module, a second teacher module, a first student module and a second student module; based on a softened interface which integrates semantic features of a previous layer with features extracted from a current layer, the first teacher module, the softened interface and the second student module are cascaded in sequence, and the first student module , the softened interface and the second teacher module are cascaded, to form two optimized paths for knowledge distillation;
(2) acquiring a low-definition image of a training set, where the training set is an open data set and includes low-definition images and high-definition images in pairs; inputting the low-definition image into the two optimized paths for feature extraction to obtain a texture detail, a high-frequency feature and an image structure of the low-definition image; generating a preliminary image result from an extracted feature map through a convolution network, and calculating a loss term based on the preliminary image result and the high-definition image to punish an incorrect image restoration by the network, where the loss term includes whether the structure is consistent, whether color conforms to a statistical law and whether the texture is natural, and finally, optimizing parameters of the two paths based on the loss; and
(3) taking out and connecting two cross-distilled student modules to form a final optimized path; inputting the low-definition image into the network; generating a super-resolution image for supervision using a complete teacher network, to calculate the loss term and update the parameters; obtaining a final compression model after training is complete and inputting the acquired low-definition image into the final compression model to obtain a super-resolution image.

Further, a purpose of knowledge transfer is achieved by aligning respective inter-layer relationship matrices of teachers and students; and a specific processing flow of output features X and Y of different layers is as follows:

$${‖ {Y}^{T} X ‖}_{F}^{2} = tr ( {XX}^{T} {YY}^{T} ) ,$$

$$CKA ( X , Y ) = \frac{{‖ {Y}^{T} X ‖}_{F}^{2}}{{‖ {X}^{T} X ‖}_{F} {‖ {Y}^{T} Y ‖}_{F}} ,$$

$$A = CKA ( {X}^{( i )} , {X}^{( j )} ) ,$$

$${ℒ}_{sim} = {‖ {A}_{T} - {A}_{S} ‖}_{1} ,$$

where tr(*) denotes a trace of a matrix, T denotes a transposition of a matrix; A_{T} and A_{S} denote an inter-layer relationship matrix of the teacher network and the student network, respectively; and ∥*∥₁ denotes L1 regularization.

Further, a softened interface is added at a cross cascade, a feature matrix is linearly mapped by using k learnable parameters to complete dimension matching between teachers and students; a softened interface is designed by using channel separation and residual connection, the softened interface preserves a low-frequency image contour through residual to prevent an image edge from blurring and a gradient of the network from disappearing, the softened interface is used to further extract a high-frequency texture through a 3*3 convolution layer, and is used for a smooth transfer of knowledge between the teacher network and the student network; and the softened interface integrates the semantic features of the previous layer with the features extracted from the current layer as a transition between teachers and students.

Further, in a cross distillation stage, the student network is optimized by minimizing reconstruction loss and similarity loss; and in an integration distillation stage, the student network is optimized by minimizing the reconstruction loss with teachers

In a second aspect, the present disclosure further provides an image super-resolution device based on a knowledge distillation compression model, wherein the device includes:

one or more processors,

a memory for storing one or more programs;

when executed by the one or more processors, the one or more programs cause the one or more processors to execute the image super-resolution method based on the knowledge distillation compression model.

In a third aspect, the present disclosure further provides a computer-readable storage medium in which one or more computer programs are stored, wherein the one or more computer programs comprise program codes which are used to execute the image super-resolution method based on the knowledge distillation compression model when the computer programs are run on a computer.

The present disclosure has the following beneficial effects:
(1) A new super-resolution network distillation method based on a cross distillation is proposed, in which the distillation is performed on by using the parameters trained by teachers directly, rather than designing the feature transformation again, and thus it is helpful to reduce the information loss during the feature transformation and improve the distillation effect.
(2) A knowledge extraction method based on the inter-layer relationship is proposed. Here, a central kernel alignment method is used to ensure that the student network learns the inter-layer relationship matrix of teachers in its own representation space, instead of directly imitating the complex representation of teachers, which improves the distillation effect.
(3) A softened interface module is proposed, which filters out harmful information in the large model based on residual connection and channel separation operation, so as to transfer knowledge smoothly and improve the distillation efficiency.
(4) Experiments show that the proposed compression method can be applied to most super-resolution networks based on deep neural networks, which can not only achieve significant parameter reduction and speed up calculation and facilitate further industrial deployment, but also effectively maintain the performance of super-resolution networks through the efficient distillation method, and better serve downstream tasks while maintaining the visual quality.

### BRIEF DESCRIPTION OF THE DRAWINGS

In order to illustrate the embodiments of the present disclosure or the technical solutions in the prior art more clearly, the accompanying drawings used in the embodiments or the prior art will be briefly described hereinafter. Obviously, the drawings in the following description are only some embodiments of the present disclosure, and other drawings can be obtained according to these drawings without any inventive effort for those skilled in the art.

FIG. 1A, FIG. 1B and FIG. 1C together constitute an overall knowledge distillation framework of a deep neural network according to the present disclosure.

FIG. 2A is a schematic diagram of a main module of a softened interface module according to the present disclosure, and FIG. 2B is a schematic diagram of an FRB sub-module of the main module of the softened interface module according to the present disclosure.

FIG. 3A, FIG. 3B, FIG. 3C, FIG. 3D and FIG. 3E together show an example of a low-resolution image input by the present disclosure, an example of an output image which has not been distilled, and an example of an image output by the present disclosure.

FIG. 4 is a structural diagram of a super-resolution network compression device based on knowledge distillation according to the present disclosure

### DETAILED DESCRIPTION OF THE EMBODIMENTS

The specific embodiments of the present disclosure will be further described in detail with reference to the accompanying drawing.

The main application scenario of the present disclosure is for the compression of the image super-resolution network. Image super-resolution means maintaining the subjective visual quality of the input image in a case of magnifying the input image multiple times. On the premise of not increasing the hardware cost, SR technology can greatly improve the resolution quality of restored images, which has high economic benefits. However, the current super-resolution network has some problems, such as large storage space, large calculation consumption and obvious delay, which makes it difficult to be deployed in practical applications such as mobile phones and edge devices, thus limiting its further application.

The present disclosure provides an image super-resolution method based on a knowledge distillation compression model, which takes an urban landscape image as an input and specifically includes the following steps.

### 1. Problem Description and Variable Definition

In the super-resolution of the urban landscape image, the purpose of inputting a small-sized low-resolution image is to output a super-resolution image with multiple times of a size of the small-sized low-resolution image according to the input image, and to maintain the visual quality of the image, such as clear building outlines and rich architectural textures. The existing standard method based on the deep neural network is as follows: for a given input image I∈R^{3*H*W}, where H and W are the height and width values of the image, respectively, the picture I is input into the network (for example, the RCAN network, Yulun Zhang, Kunpeng Li, Kai Li, Lichen Wang, Bineng Zhong, and Yun Fu. Image super-resolution using very deep residual channel attention networks. In Proceedings of the European conference on computer vision (ECCV), pages 286-301, 2018.), and the result Y₀∈R^{3*4H*4W} is output through the quadruple super-resolution network.

### 2. A Knowledge Distillation Framework of the Present Disclosure

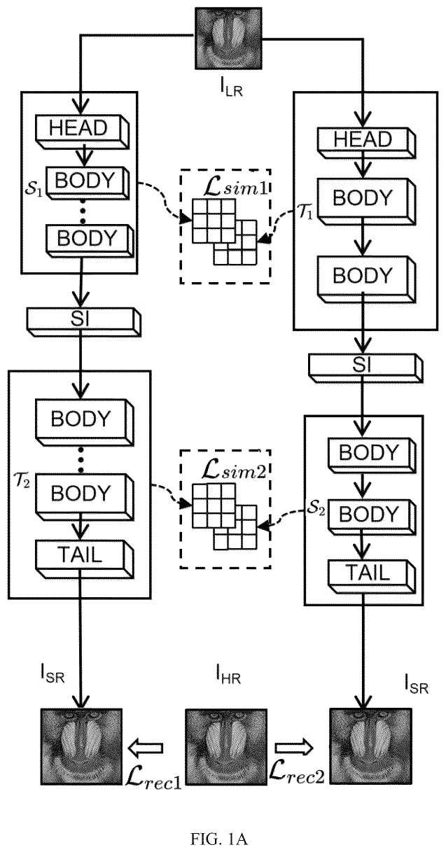

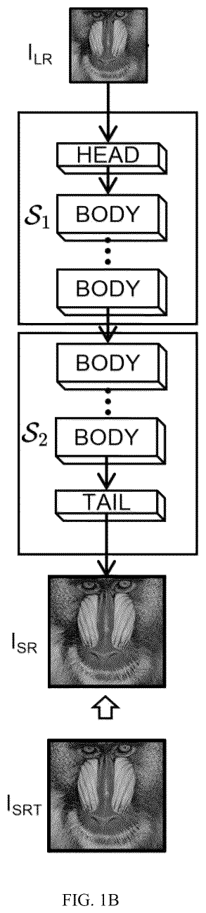

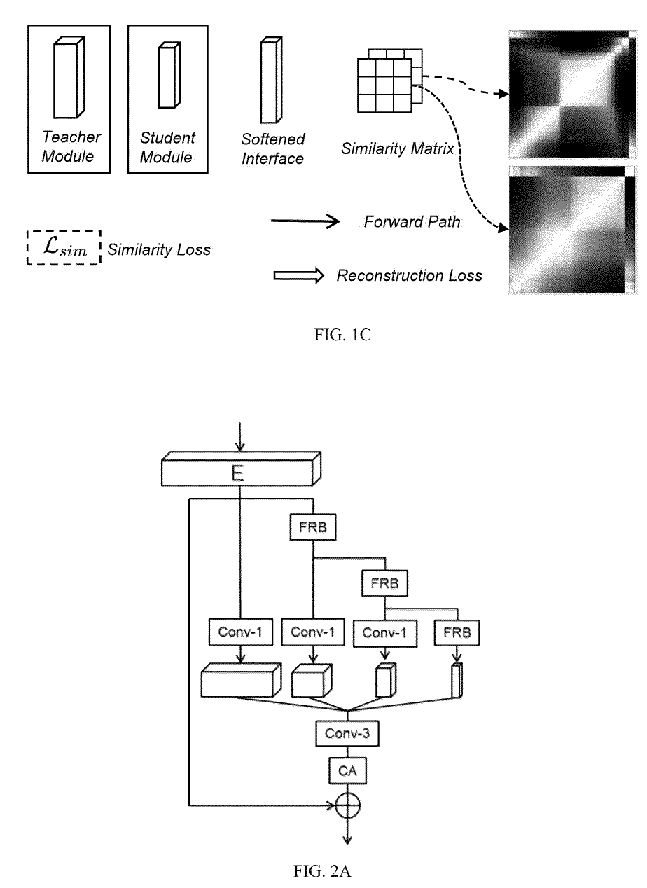

The present disclosure designs a super-resolution network distillation framework based on cross distillation, and intends to directly use teachers for supervision, so as to avoid the explicit conversion of feature maps. Because the super-resolution network usually consists of three parts: a head block with only one convolution layer for shallow feature extraction, N repeated main blocks for generating high-frequency details, and an upsampled tail block for high-quality reconstruction of the final image. As shown in FIG. 1A, FIG. 1B and FIG. 1C, the cross distillation framework of the present disclosure consists of two main steps, that is, the cross distillation stage as shown in FIG. 1A, and the integration training stage as shown in FIG. 1B.

In the cross distillation stage, as shown in FIG. 1A, the pre-trained teacher [symbol] is divided into two parts of T1 and T2 according to blocks, where the head block and the first half of main blocks connected with the head block form [symbol] ₁, and the tail block and the second half of main blocks form [symbol] ₂. The number of the main blocks of the student network is less than that of the teacher network, and the main blocks are divided into [symbol] ₁ and [symbol] ₂ by the same method. [symbol] ₁ and [symbol] ₂, [symbol] ₂ and [symbol] ₁ are respectively cascaded to obtain two new networks, which form an upper optimized path and a lower optimized path. The upper optimized path consists of two modules [symbol] ₁ and [symbol] ₂. The lower optimized path consists of two modules [symbol] ₂ and [symbol] ₁. The parameters of the teacher module are fixed to supervise the student module. The parameters of teachers are fixed in training to guide students, so that specific texture and detail features can be extracted from images by the parameters of teachers during processing, and these features with less information loss can be used to further guide the parameter optimization of the student network. In paired training data, the following loss function can be minimized:

$${ℒ}_{rec 1} = {\sum }_{i = 1}^{N} {‖ {I}_{HR}^{i} - {𝒥}_{2} ( {𝒮}_{1} ( {I}_{LR}^{i} ) ) ‖}_{1} ,$$

$${ℒ}_{rec 2} = {\sum }_{i = 1}^{N} {‖ {I}_{HR}^{i} - {𝒮}_{2} ( {𝒥}_{1} ( {I}_{LR}^{i} ) ) ‖}_{1} ,$$

where I_{LR}ⁱ denotes a low-definition image, and I_{HR}ⁱ denotes a high-definition image, which are paired. N denotes the number of training images, and ∥*∥₁ denotes L1 regularization. Using the high-definition image as constraints, the loss terms of the two paths are optimized, respectively, and the first stage of distillation is completed through supervised training. The main purpose of this stage is to decompose the student module and construct a super-resolution network with the parameters trained by the teacher to achieve the purpose of distillation.

In the present disclosure, in the integration stage, the student module trained in the previous stage is taken out of the cascade network, and then reassembled into a final small network. As shown in FIG. 1B, the small network is further integrated under the supervision of the super-resolution images output by teachers to improve the final performance of the small network. Under the supervision of teachers, this process can be completed by minimizing the following losses:

$${ℒ}_{fu} = {\sum }_{i = 1}^{N} {‖ 𝒥 ( {I}_{LR}^{i} ) - {𝒮}_{2} ( {S}_{1} ( {I}_{LR}^{i} ) ) ‖}_{1} ,$$

### 3. A Softened Interface (SI) of the Present Disclosure

The present disclosure designs a Softened interface (SI), the purpose of which is to alleviate the capacity difference between teachers and students to improve the distillation efficiency. Because of the difference in the number of parameters between teachers and students, the representation capability will be different. The ability of the teacher module is much stronger than that of the student module, and the difference will lead to inefficient distillation. In order to alleviate this problem, the present disclosure designs a softened interface based on residual connection and channel separation as a transition between modules to filter out harmful information in the teacher network and improve the overall distillation efficiency. The interface is inserted between the teacher network and the student network to improve the efficiency of knowledge transmission.

The overall design idea of the SI softened interface is as follows. First, the size of the output of the teacher module is adjusted, and a linear embedding module E is used to reduce the dimension of the output feature map F of teachers to obtain F₀ to match the input required by students. Thereafter, the feature F₀ is sent to the sub-module for layer-by-layer distillation, and the feature map generated by the teacher network is gradually extracted. Finally, the modules extracted from each layer are spliced and integrated with a convolution layer again, and the feature map required by the student network is output. As a transition between teachers and students, this softened interface can alleviate the problem of inefficient distillation, filter the main image features such as the structure, the color and the texture to the student network, and filter out some irrelevant image noise and harmful information, thus improving the visual quality of super-resolution images.

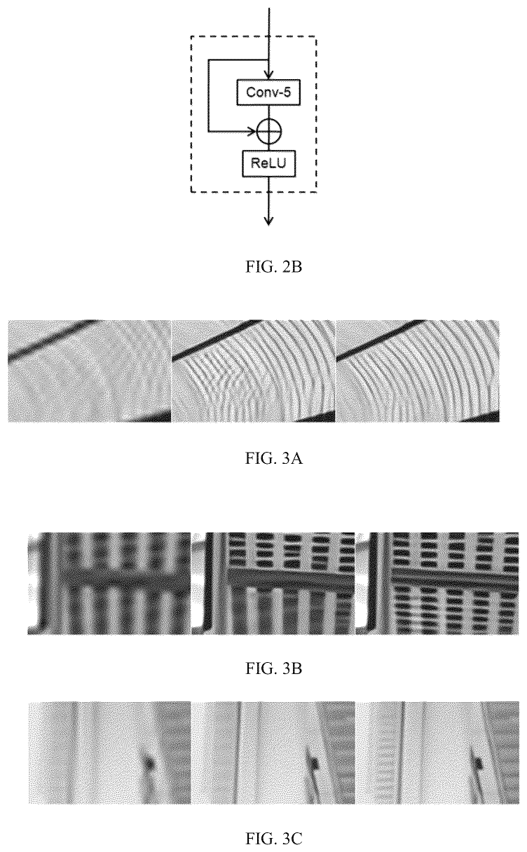

Specifically, as shown in FIG. 2A and FIG. 2B, the main module is shown in FIG. 2A, and an FRB (Feature Refine Block) sub-module is shown in FIG. 2B. The feature map generated by the teacher module is denoted as F∈R^{C*H*W}, where C, H and W denote the size, height and width of a tensor channel. First, a linear embedding module E is used to reduce the dimension of F to match the input required by students:

$${F}_{0} = E ( F ) ,$$

where F₀ denotes the output, and E is the 3*3 convolution of the number C of input channels and the number C/2 of output channels. Then, F₀ is sent to the designed module, and multiple repeated sub-modules are used to gradually improve feature extraction and refine features As shown in FIG. 2A and FIG. 2B, the present disclosure performs two types of processing on the input feature F₀ as follows: (1) the dimension of the input channel is compressed to half of the original dimension using 1×1 convolution, and the new feature F₁ is directly sent to the final integration module.

$${F}_{1} = {C}_{0} ( {F}_{0} ) ,$$

where C₀ denotes the 1×1 convolution layer.
(2) The input F₀ is sent to the sub-module M₀ for refinement, and a new distillation feature F_{distilled_1} is further generated as follows:

$${F}_{distilled \_ 1} = {M}_{0} ( {F}_{0} )$$

The structure of the sub-module M is shown in FIG. 2B, which consists of a 5*5 convolution layer and a nonlinear layer ReLU. Therefore, each stage will produce two features, that is, Fₖ and F_{distilled_k}. The newly generated feature F_{distilled_k} will be further processed by the next modules Cₖ and M_{K}.

$${F}_{k + 1} = {C}_{k} ( {F}_{distilled \_ k} ) , k = 1 , … , n ,$$

$${F}_{distilled \_ k + 1} = {M}_{k} ( {F}_{distilled \_ k} ) , k = 1 , … , n .$$

In the last integration layer, all the features produced by the 1×1 convolution layer are connected with the features of the last distillation, which is shown as follows:

$${F}_{all} = Concat ( {F}_{1} , … , {F}_{k} , {F}_{distilled \_ k} ) , k = 1 , … , n$$

Moreover, the features are added to the input feature F₀ to obtain a refined feature map.

Finally, the feature map is reconstructed as follows.

$${F}_{all} = R ( {F}_{all} + {F}_{0} ) ,$$

where R includes a 3×3 convolution layer.

### 4. A Structural Similarity Loss of The Present Disclosure

In the present disclosure, a behavioral similarity loss function is designed, aiming at adding finer-grained supervision to strengthen the distillation effect. Based on the central kernel alignment method, the present disclosure defines the relationship between network layers as knowledge. By aligning the similarity matrixes, the purpose of distillation is achieved, and at the same time, the direct alignment of the feature maps between the two networks is avoided. As shown in FIG. 1A, the present disclosure adds similarity loss between teachers and students so that the student network further learns the inter-layer relationship of teachers, so as to achieve further fine-grained constraints and improve the reconstruction ability of model images. First, the similarity matrix of module is generated. Taking RCAN network as an example, as shown in FIG. 1A, [symbol] ₁ module consists of a head part and 10 main blocks. The correlation of every two feature maps generated by 10 main blocks are compared. Two features are denoted as X and Y, which denote the feature output of the middle layer. tr(*) denotes a trace of a matrix, and T denotes a transposition of a matrix. When the linear kernel is selected, the correlation of the two features X and Y can be obtained by the CKA formula:

$$CKA ( X , Y ) = \frac{{‖ {Y}^{T} X ‖}_{F}^{2}}{{‖ {X}^{T} X ‖}_{F} {‖ {Y}^{T} Y ‖}_{F}} ,$$

$${‖ {Y}^{T} X ‖}_{F}^{2} = tr ( {XX}^{T} {YY}^{T} ) .$$

Through the CKA method, the similarity relationship between different layers can be obtained, and the similarity relationship matrix A_{T1} is established:

$${A}_{T 1} = CKA ( {X}^{( i )} , {X}^{( j )} ) ,$$

where X⁽ⁱ⁾ and X^{(j)} represent the feature outputs of different layers. Since [symbol] ₁ contains the features of 10 processed images, the matrix A_{T1} with the size of 10*10 can be obtained.

Using the same formula, the self-similarity matrices A_{T2}, A_{S1} and A_{S2} of the three remaining modules [symbol] ₂, [symbol] ₁ and [symbol] ₂ can be obtained.

Then, the self-similarity matrices A_{T1} and A_{S2} generated by the two modules [symbol] ₁ and [symbol] ₂ in their respective representation space, and the self-similarity matrices A_{T2} and A_{S1} generated by the two modules [symbol] ₂ and [symbol] ₁ in their representation space are aligned in pairs, so as to minimize the loss:

$${ℒ}_{sim 1} = {‖ {A}_{{T}_{1}} - {A}_{{S}_{1}} ‖}_{1} ,$$

$${ℒ}_{sim 2} = {‖ {A}_{{T}_{2}} - {A}_{{S}_{2}} ‖}_{1} .$$

The loss functions [symbol] ₛᵢₘ₁ and [symbol] ₛᵢₘ₂ are minimized, and the behavior consistency between the student network and the teacher network is ensured, so as to achieve the purpose of transmitting the knowledge of teachers and obtaining details and textures of the high-quality restored image. By minimizing the proposed similarity loss, the knowledge of teachers is transferred to the student module, which ensures ability of teachers to extract image textures and details and transfers the ability to the student network. Using relational features can make the student module learn the similarity of features in their own representation space, without directly imitating the complex representation space of teachers. Because the teacher network will produce a large number of image textures, it is not easy for students to imitate directly.

### 5. Overall Loss Term

In the cross distillation stage, the loss term consists of two parts: the reconstruction loss of urban landscape image supervision and the behavioral similarity loss based on CKA. The reconstruction loss consists of [symbol] ₁ norm of super-resolution images and high-resolution city images output by two paths, namely, [symbol] _{rec1} and [symbol] _{rec2}, which aims to make the output of the whole network as close to the real city image as possible. The behavioral similarity loss consists of [symbol] ₛᵢₘ₁ and [symbol] ₛᵢₘ₂, which aims to cause students to imitate the inter-layer similarity of teachers, so as to achieve finer-grained supervision and preserve the texture details in the landscape. Therefore, the loss of the cross distillation stage is:

$${ℒ}_{total 1} = {ℒ}_{rec 1} + {ℒ}_{sim 1} ,$$

$${ℒ}_{total 2} = {ℒ}_{rec 2} + {ℒ}_{sim 2} .$$

In this stage, a total of 100 generations are trained.

In the integration distillation stage, students are taken out from two optimized paths, and two student modules are cascaded again without the softened interface. The integration loss is used for further training. Different from the previous stage, this stage uses the super-resolution image generated by the complete teacher [symbol] for supervision, namely:

$${ℒ}_{fu} = {\sum }_{i = 1}^{N} {‖ 𝒥 ( {I}_{LR}^{i} ) - {𝒮}_{2} ( {𝒮}_{1} ( {I}_{LR}^{i} ) ) ‖}_{1} .$$

In this stage, a total of 100 generations are also trained.

The embodiment of the super-resolution data set restoration task of the present disclosure is as follows.
(1) preparatory work

First, the data sets DIV2K and Urban100 for the experiment need to be prepared. The DIV2K data set has 800 high-definition images and corresponding low-resolution images for neural network training. The low-definition image is obtained by down-sampling the high-definition image, and the size thereof is one quarter of the original image. Urban100 is a typical urban landscape data set in the super-resolution task, which contains 100 high-definition urban landscape images, and the texture of the high-definition urban landscape image is complex and covers a wide range of urban landscapes. Taking it as a test set, high-quality image super-resolution, that is, high subjective visual quality and high objective indicators, can test the effectiveness of the algorithm.
(2) hyper-parameters are set, and the main hyper-parameters are as shown in Table 1:

TABLE 1

| Name of hyper-parameters | Initial learning rate | epoch | Batch size |
|---|---|---|---|
| Values | 0.0001 | 200 | 16 |

(3) the DIV2K data set is selected to train the network, and the network accuracy is tested after the training. As shown in Table 2, when the super-resolution network is EDSR (Jiwon Kim, Jung Kwon Lee, and Kyoung Mu Lee. Accurate image super-resolution using very deep convolutional networks. In Proceedings of the IEEE conference on computer vision and pattern recognition, pages 1646-1654, 2016.) and RCAN, in the experiment in which the test data set is Urban100, the PSNR of EDSR network without distillation is 25.631 dB and the SSIM thereof is 0.7707. After using the frame distillation proposed by the present disclosure, the PSNR is 25.799 dB and the SSIM is 0.7766. The PSNR of RCAN network without distillation is 26.340 dB and the SSIM thereof is 0.7933. After using the frame distillation proposed by the present disclosure, the PSNR is 26.519 dB and the SSIM is 0.7992. It can be concluded that the objective index of the super-resolution network is obviously improved under the same parameter quantity after the distillation of the present disclosure, which is helpful to realize the high-quality application of downstream tasks related to urban landscapes.

TABLE 2

| Index | Distilled | Undistilled | Distilled | Undistilled |
|---|---|---|---|---|
| Name | EDSR | EDSR | RCAN | RCAN |
| PSNR | 25.799 | 25.631 | 26.519 | 26.340 |
| SSIM | 0.7766 | 0.7707 | 0.7992 | 0.7933 |

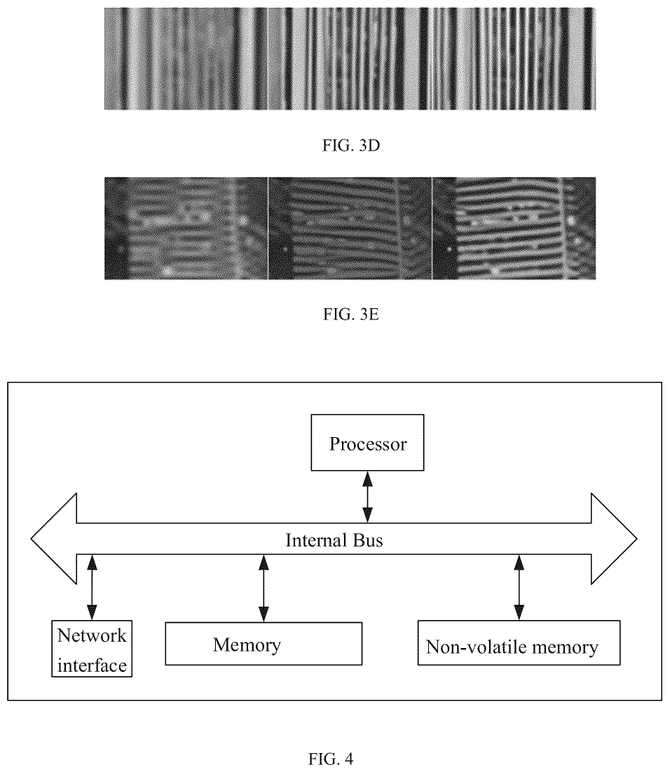

(4) Image analysis: take the picture to be subjected to super-resolution on the leftmost side of FIG. 3A, FIG. 3B, FIG. 3C, FIG. 3D and FIG. 3E as an example to analyze the results. This picture is a low-resolution image of the urban landscape type characterized by regular texture structure and high repetition. The goal of the image super-resolution task is to obtain larger-sized super-resolution images, which are generally 2 times, 3 times and 4 times the size of the low-resolution image. Compared with the teacher network which is difficult to deploy, the present disclosure compresses EDSR and RCAN by 32 times and 3 times, respectively. The rightmost column of FIG. 3A, FIG. 3B, FIG. 3C, FIG. 3D and FIG. 3E is a 4- times super-resolution image output by the RCAN model distilled by the present disclosure. The middle column is the images output by the RCAN model directly trained and not distilled by the present disclosure. These two models have the same size and can be deployed on edge devices. However, it can be observed that compared with the models trained directly, the result of the present disclosure has a clearer and more consistent restored urban landscape texture structure, as well as better subjective visual perception. The algorithm of the present disclosure restores a pleasant urban landscape image, which can be quickly deployed on the mobile phone. It can also help restore low-quality remote sensing satellite images, help identify urban landscapes, and further process geographic information.

Corresponding to the aforementioned embodiment of the super-resolution network compression method based on knowledge distillation, the present disclosure further provides an embodiment of an image super-resolution device based on a knowledge distillation compression model.

Referring to FIG. 4, an image super-resolution device based on a knowledge distillation compression model provided by an embodiment of the present disclosure includes a memory and one or more processors, wherein executable codes are stored in the memory, and when the executable codes are executed, the processors are used to implement the image super-resolution method based on the knowledge distillation compression model in the above embodiment.

An embodiment of an image super-resolution device based on a knowledge distillation compression model according to the present disclosure can be applied to any device with data processing capability, which can be a device or an apparatus such as a computer. The embodiment of the device can be implemented by software, or by hardware or a combination of hardware and software. Taking software implementation as an example, a logical device is formed by reading the corresponding computer program instructions in the non-volatile memory into the memory through the processor of any device with data processing capability and then running the instructions. From the hardware level, as shown in FIG. 4, it is a hardware structure diagram of any device with data processing capability where the image super-resolution device based on the knowledge distillation compression model of the present disclosure is located. Besides the processor, the memory, the network interface and the nonvolatile memory shown in FIG. 4, any device with data processing capability where the device is located in the embodiment usually includes other hardware according to the actual function thereof, which will not be described in detail here again.

The implementation process of the functions and effects of each unit in the above-mentioned device is detailed in the implementation process of the corresponding steps in the above-mentioned method, which will not be described in detail here again.

Because the device embodiment basically corresponds to the method embodiment, it is only necessary to refer to part of the description of the method embodiment for the relevant points. The device embodiments described above are only schematic, in which the units described as separate components may or may not be physically separated, and the components displayed as units may or may not be physical units, that is, they may be located in one place or distributed on multiple network units. Some or all of the modules can be selected according to actual needs to achieve the purpose of the solutions of the present disclosure. Those skilled in the art can understand and implement the purpose without inventive effort.

The embodiment of the present disclosure further provides a computer-readable storage medium in which a program is stored, which, when executed by a processor, implements the image super-resolution method based on the knowledge distillation compression model in the above embodiment.

The computer-readable storage medium can be an internal storage unit of any device with data processing capability as described in any of the previous embodiments, such as a hard disk or a memory. The computer-readable storage medium can also be an external storage device of any device with data processing capability, such as a plug-in hard disk, a Smart Media Card (SMC), an SD card, a Flash Card, etc. equipped on the device. Further, the computer-readable storage medium can further include both an internal storage unit and an external storage device of any device with data processing capability. The computer-readable storage medium is used to store the computer program and other programs and data required by any device with data processing capability, and can also be used to temporarily store data that has been output or will be output.

The above-mentioned embodiments are used to explain the present disclosure, rather than limit the present disclosure. Any modification and change made to the present disclosure within the scope of protection of the spirit and claims of the present disclosure fall within the scope of protection of the present disclosure.

1. An image super-resolution method based on a knowledge distillation compression model, comprising:
(1) acquiring a trained large teacher network and a small student network to be trained respectively, wherein the teacher network is an open and pre-trained network; the student network is a network obtained after reducing a depth of the teacher network, which will be used for actual deployment; the teacher network and the student network are respectively divided into two modules according to a network depth to obtain a first teacher module, a second teacher module, the first student module and the second student module; based on a softened interface which integrates semantic features of a previous layer with features extracted from a current layer, the first teacher module, the softened interface and the second student module are cascaded in sequence, and the first student module, the softened interface and the second teacher module are cascaded, to form two optimized paths for knowledge distillation;
(2) acquiring a low-definition image of a training set, wherein the training set is an open data set and comprises low-definition images and high-definition images in pairs; inputting the low-definition image into the two optimized paths for feature extraction to obtain a texture detail, a high-frequency feature and an image structure of the low-definition image; generating a preliminary image result from an extracted feature map through a convolution network, and calculating a loss term based on the preliminary image result and the high-definition image to punish an incorrect image restoration by the network, wherein the loss term comprises whether the structure is consistent, whether color conforms to a statistical law and whether the texture is natural; and finally, optimizing parameters of the two paths based on the loss; and
(3) taking out and connecting two cross-distilled student modules to form a final optimized path; inputting the low-definition image into the network; generating a super-resolution image for supervision using a complete teacher network, to calculate the loss term and update the parameters; obtaining a final compression model after training is complete and inputting the acquired low-definition image into the final compression model to obtain a super-resolution image.

2. The image super-resolution method based on the knowledge distillation compression model according to claim 1, wherein a purpose of knowledge transfer is achieved by aligning respective inter-layer relationship matrices of teachers and students; and a specific processing flow of output features X and Y of different layers is as follows:
$${‖ {Y}^{T} X ‖}_{F}^{2} = tr ( {XX}^{T} {YY}^{T} ) ,$$
$$CKA ( X , Y ) = \frac{{‖ {Y}^{T} X ‖}_{F}^{2}}{{‖ {X}^{T} X ‖}_{F} {‖ {Y}^{T} Y ‖}_{F}} ,$$
$$A = CKA ( {X}^{( i )} , {X}^{( j )} ) ,$$
$${ℒ}_{sim} = {‖ {A}_{T} - {A}_{S} ‖}_{1} ,$$
where tr(*) denotes a trace of a matrix, T denotes a transposition of a matrix; A_{T} and A_{S} denote an inter-layer relationship matrix of the teacher network and the student network, respectively; and ∥*∥₁ denotes L1 regularization.

3. The image super-resolution method based on the knowledge distillation compression model according to claim 1, wherein a softened interface is added at a cross cascade, a feature matrix is linearly mapped by using k learnable parameters to complete dimension matching between teachers and students; a softened interface is designed by using channel separation and residual connection, the softened interface preserves a low-frequency image contour through residual to prevent an image edge from blurring and a gradient of the network from disappearing, the softened interface is used to further extract a high-frequency texture through a 3*3 convolution layer, and is used for a smooth transfer of knowledge between the teacher network and the student network; and the softened interface integrates the semantic features of the previous layer with the features extracted from the current layer as a transition between teachers and students.

4. The image super-resolution method based on the knowledge distillation compression model according to claim 1, wherein in a cross distillation stage, the student network is optimized by minimizing reconstruction loss and similarity loss; and in an integration distillation stage, the student network is optimized by minimizing the reconstruction loss with teachers.

5. An image super-resolution device based on a knowledge distillation compression model, comprising:
one or more processors;
a memory for storing one or more programs;
when executed by the one or more processors, the one or more programs cause the one or more processors to execute the image super-resolution method based on the knowledge distillation compression model according to claim 1.

6. (canceled)

7. The image super-resolution device based on the knowledge distillation compression model according to claim 5, wherein a purpose of knowledge transfer is achieved by aligning respective inter-layer relationship matrices of teachers and students; and a specific processing flow of output features X and Y of different layers is as follows:
$${‖ {Y}^{T} X ‖}_{F}^{2} = tr ( {XX}^{T} {YY}^{T} ) ,$$
$$CKA ( X , Y ) = \frac{{‖ {Y}^{T} X ‖}_{F}^{2}}{{‖ {X}^{T} X ‖}_{F} {‖ {Y}^{T} Y ‖}_{F}} ,$$
$$A = CKA ( {X}^{( i )} , {X}^{( j )} ) ,$$
$${ℒ}_{sim} = {‖ {A}_{T} - {A}_{S} ‖}_{1} ,$$
where tr(*) denotes a trace of a matrix, T denotes a transposition of a matrix; A_{T} and A_{S} denote an inter-layer relationship matrix of the teacher network and the student network, respectively; and ∥*∥₁ denotes L1 regularization.

8. The image super-resolution device based on the knowledge distillation compression model according to claim 5, wherein a softened interface is added at a cross cascade, a feature matrix is linearly mapped by using k learnable parameters to complete dimension matching between teachers and students; a softened interface is designed by using channel separation and residual connection, the softened interface preserves a low-frequency image contour through residual to prevent an image edge from blurring and a gradient of the network from disappearing, the softened interface is used to further extract a high-frequency texture through a 3*3 convolution layer, and is used for a smooth transfer of knowledge between the teacher network and the student network; and the softened interface integrates the semantic features of the previous layer with the features extracted from the current layer as a transition between teachers and students.

9. The image super-resolution device based on the knowledge distillation compression model according to claim 5, wherein in a cross distillation stage, the student network is optimized by minimizing reconstruction loss and similarity loss; and in an integration distillation stage, the student network is optimized by minimizing the reconstruction loss with teachers.

10. A computer-readable storage medium in which one or more computer programs are stored, wherein the one or more computer programs comprise program codes which are used to execute the image super-resolution method based on the knowledge distillation compression model according to claim 1 when the computer programs are run on a computer.

11. The computer-readable storage medium in which one or more computer programs are stored according to claim 10, wherein a purpose of knowledge transfer is achieved by aligning respective inter-layer relationship matrices of teachers and students; and a specific processing flow of output features X and Y of different layers is as follows:
$${‖ {Y}^{T} X ‖}_{F}^{2} = tr ( {XX}^{T} {YY}^{T} ) ,$$
$$CKA ( X , Y ) = \frac{{‖ {Y}^{T} X ‖}_{F}^{2}}{{‖ {X}^{T} X ‖}_{F} {‖ {Y}^{T} Y ‖}_{F}} ,$$
$$A = CKA ( {X}^{( i )} , {X}^{( j )} ) ,$$
$${ℒ}_{sim} = {‖ {A}_{T} - {A}_{S} ‖}_{1} ,$$
where tr(*) denotes a trace of a matrix, T denotes a transposition of a matrix; A_{T} and A_{S} denote an inter-layer relationship matrix of the teacher network and the student network, respectively; and ∥*∥₁ denotes L1 regularization.

12. The computer-readable storage medium in which one or more computer programs are stored according to claim 10, wherein a softened interface is added at a cross cascade, a feature matrix is linearly mapped by using k learnable parameters to complete dimension matching between teachers and students; a softened interface is designed by using channel separation and residual connection, the softened interface preserves a low-frequency image contour through residual to prevent an image edge from blurring and a gradient of the network from disappearing, the softened interface is used to further extract a high-frequency texture through a 3*3 convolution layer, and is used for a smooth transfer of knowledge between the teacher network and the student network; and the softened interface integrates the semantic features of the previous layer with the features extracted from the current layer as a transition between teachers and students.

13. The computer-readable storage medium in which one or more computer programs are stored according to claim 10, wherein in a cross distillation stage, the student network is optimized by minimizing reconstruction loss and similarity loss; and in an integration distillation stage, the student network is optimized by minimizing the reconstruction loss with teachers.
